(19) United States
(12) Patent Application Publication
(10) Pub. No.: US 2006/0203443 A1
(43) Pub. Date: Sep. 14, 2006

(54) Wiring rack for fixing signal lines

(76) Inventor: Yung Cheng Chang, Taipei (TW)

Correspondence Address: LIN & ASSOCIATES INTELLECTUAL PROPERTY, P.O. BOX 2339, SARATOGA, CA, 95070-0339, US

(21) Appl. No.: 11/075,246

(22) Filed: Mar. 8, 2005

(51) Int. Cl. G06F 1/16

(52) U.S. Cl. 361/686

(57) ABSTRACT

A wiring rack for fixing signal lines is proposed to keep and space a plurality of signal lines in a specific interval from each other. The wiring rack is substantially a rectangular main body formed with fixing grooves, and a clamping portion of the rectangular main body is extended from both lateral sides. When the signal lines are pressed into the fixing grooves, the clamping portion is enabled to clamp and support the extension portion of a signal coupling of the signal lines.

### BACKGROUND OF THE INVENTION

1. Field of the Invention

The present invention relates to wiring racks of signal lines, and more particularly to a wiring rack, which is provided with fixing grooves narrower in width than the signal lines to be fixed.

2. The Prior Arts

FIGS. 1A and 1B are schematic views showing conventional soldering wires. As indicated in FIG. 1A, one end of a signal coupling 10 is an extension portion 10a, which is provided with a single- or double-face soldering portion 10b (a double-face one according to FIG. 1A). Referring to FIG. 1B, the core 12a of signal lines 12 are attached to the soldering portion 10b such that the signals at the other end of the signal coupling 10 can be transmitted to signal lines 12 through the soldering portion 10b, then to an electronic element or device at the other end of the signal lines 12.

For protecting the signal lines 12 as well as the cores 12a, particularly the part of cores on the soldering portion 10b, a plastic formation is adopted to invest the signal lines 12, the cores 12a, the extension portion 10a, and the soldering portion 10b to become a cable (not shown), but during formation, the cores 12a of the signal lines 12 might be entangled to result in a change of conductivity or a yield decrease.

### SUMMARY OF THE INVENTION

The major objective of the present invention is to provide a wiring rack for fixing signal lines, which is capable of spacing a plurality of signal lines in a specific interval from each other without causing any displacement of signal line due to formation pressure of plastic material.

A minor objective of the present invention is to provide a wiring rack having a long enough wiring space for avoiding detachment of a core from a soldering portion even when pulling and pushing the signal line, so that the production yield can be increased.

In order to realize above-mentioned objectives, a wiring rack for fixing signal lines is substantially a rectangular main body formed with fixing grooves wherein each groove is narrower in width than a signal line; and a clamping portion of the rectangular main body is extended from both lateral sides. After the signal lines are pressed into the fixing grooves, the clamping portion is enabled to clamp and support the extension portion of signal coupling of the signal lines.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIGS. 1A and 1B are schematic views showing the conventional soldering wires;

FIG. 2 is a schematic view of wiring rack of the present invention;

FIGS. 3A through 3C are schematic views of the soldering wires applied in the present invention; and

FIGS. 4A and 4B are schematic views of a cover of the present invention.

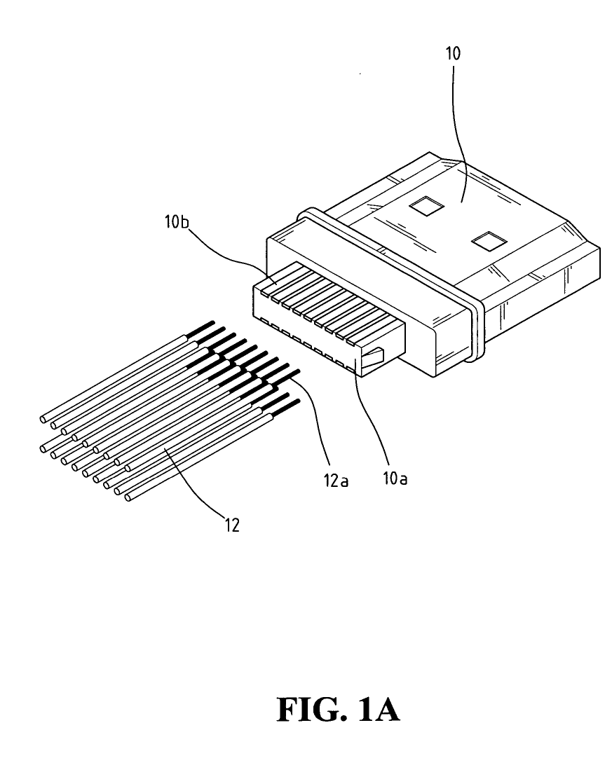

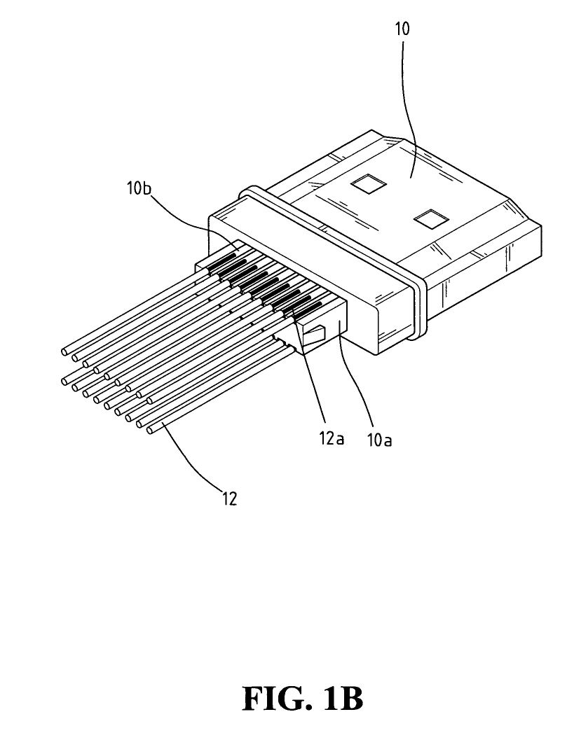

### DETAILED DESCRIPTION OF THE PREFERRED EMBODIMENT

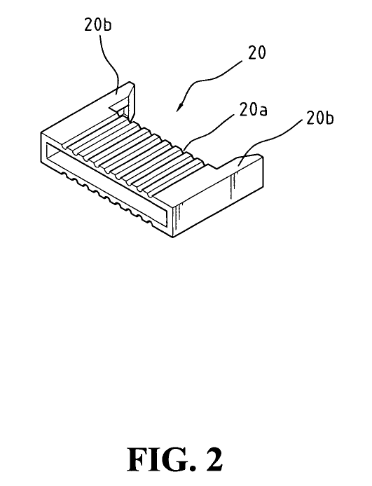

FIG. 2 is a schematic view of wiring rack of the present invention. As shown in FIG. 2, a wiring rack 20 of the present invention is substantially a rectangular main body provided either in one single surface or in two surfaces with fixing groves 20a, and with two clamping portions 20b extended laterally therefrom.

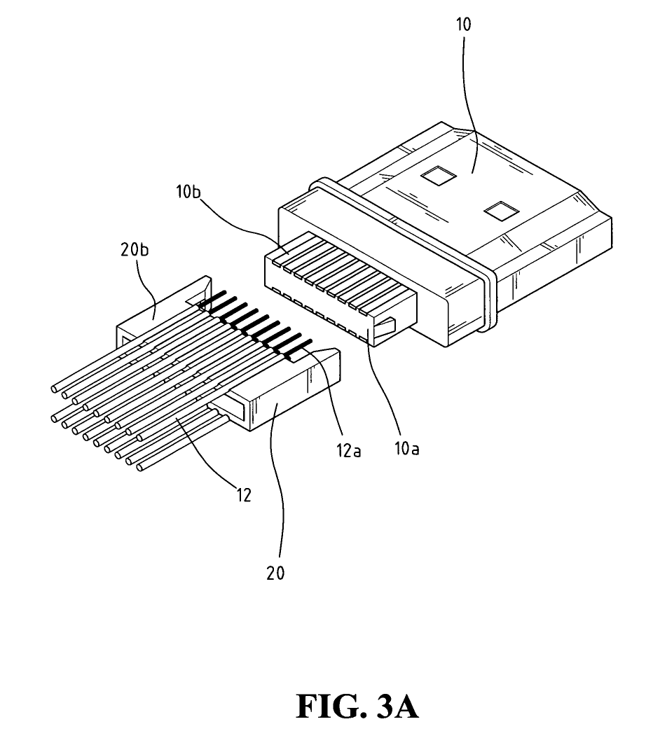

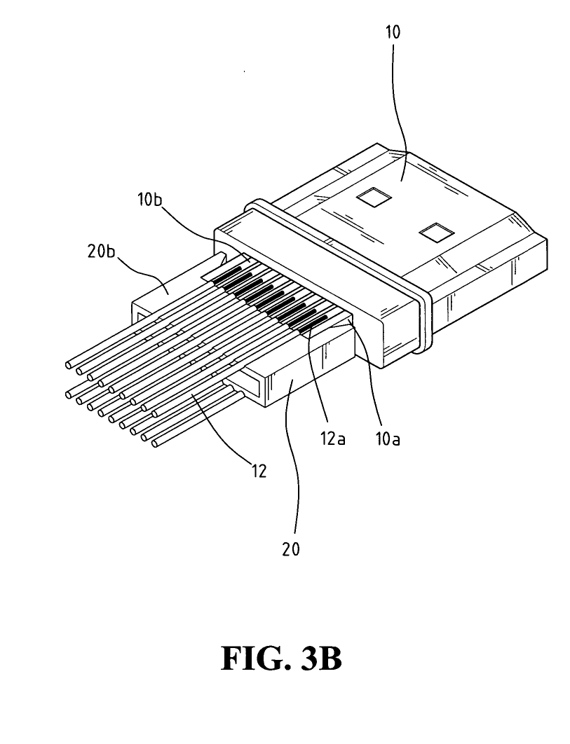

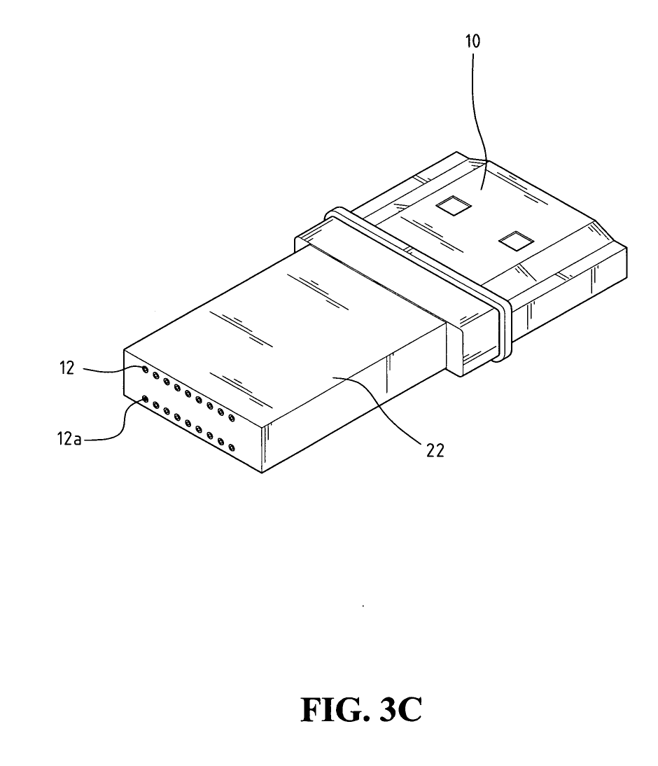

FIGS. 3A through 3C are schematic views of the soldering wires applied in the present invention. As indicated in FIG. 3A, one end of a signal coupling 10 is an extension portion 10a, and a soldering portion 10b is formed on a single surface or on two surfaces thereof (two surfaces in the case shown in FIG. 3A).

Since the width of each fixing groove 20a is slightly narrower than the diameter of every signal line 12, and the insulation layer adopted for investing a core 12a of the signal line 12 is made of a resilient plastic material, therefore, the signal lines 12 can be pushed into the fixing grooves 20a and checked there and spaced by a specific interval from each other. In addition, the fixing grooves 20a are usually in U-shape for easy and intimate combination of the cylindrical signal lines 12 with the grooves.

In order to facilitate the soldering of the core 12a of the signal line 12 to the soldering portion 10b, the clamping portion 20b of the wiring rack 20 is used to clamp the extension portion 10a of the signal coupling 10. Referring to FIG. 3B, as the wiring rack 20 is slightly wider than the extension portion 10a, hence, those two clamping portions 20b laterally extended from the wiring rack 20 can clamp the extension portion 10a tightly when it is pushed into the latter due to the characteristics of material. Or, it is also feasible to press the signal lines 12 into the fixing grooves 20a after the wiring rack 20 has clamped the extension portion 10a.

After the wiring rack 20 has clamped the extension portion 10a, the core 12a of the signal line 12 is then soldered to attach the soldering portion 10b so that signals transmitted from or received by the plug holes on the other side of the signal coupling 10 can be transferred to the signal line 12 through the soldering portion 10b, then transferred to an electronic element or device on the other end from the signal line 12.

Finally, the extension portion 10a, the wiring rack 20, and the signal lines 12 on the wiring rack 20 are clad with plastic material to form a cable 22, as shown in FIG. 3C.

In short, according to above described, in the cable 22 shown in FIG. 3C, a plurality of signal lines 12 can be spaced in a specific interval from each other by means of the wiring rack 20 without causing any displacement of signal line. Moreover, since the wiring rack 20 of the present invention can provide a long enough wiring space, any possible detachment of the core 12a from the soldering portion 10b because of pulling the signal lines 12 could be thus avoid to thereby increase yield.

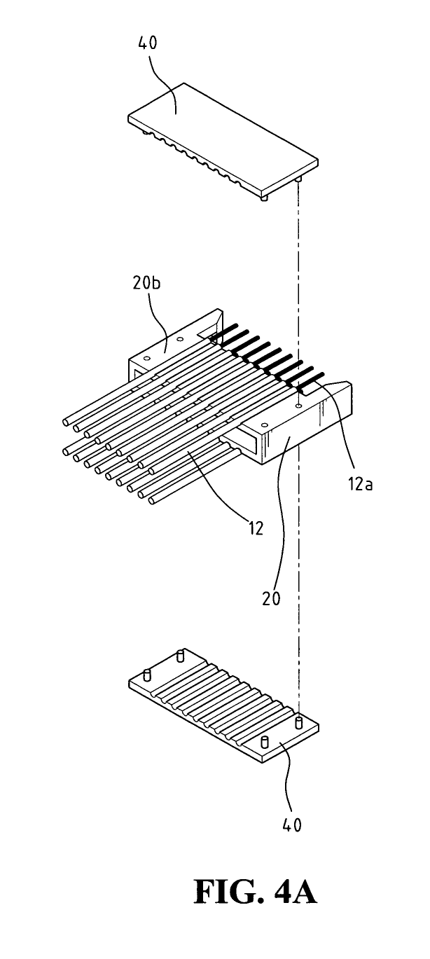

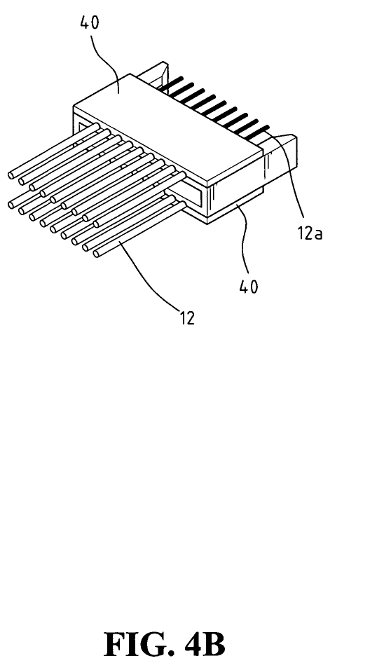

FIGS. 4A and 4B are schematic views of a cover of the present invention. As shown in FIG. 4A, at lest a pair of screw holes is arranged in the rectangular main body provided with fixing grooves (shaded by the signal lines 12), and the wiring rack 20 is further comprised of a cover 40 having fixing posts at positions corresponding with the screw holes of the main body. As the fixing posts are slightly shorter than the screw holes in diameter, thus, the fixing posts will be inserted in the screw holes tightly to thereby fix the cover 40 on the rectangular main body, as shown in FIG. 4B.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A wiring rack for fixing signal lines, wherein a plurality of signal lines is spaced in a specific interval, a core of each signal line is clad with an insulation layer while the exposed part of the core is soldered to attach on a soldering portion of a signal coupling, and one end of the signal coupling is provided with an extension portion for supporting the soldering portion, the wiring rack comprising:
a rectangular main body;
a fixing groove located on the main body, having a width slightly narrower than the signal line; and
a clamping portion extended from two lateral sides respectively of the rectangular main body, the clamping portion selectively clamping the extension portion of the signal coupling when the signal line is pressed into the fixing groove.

2. The wiring rack as claimed in claim 1, wherein the fixing groove is located on a single surface of the rectangular main body.

3. The wiring rack as claimed in claim 1, wherein the fixing groove is located on two surfaces of the rectangular main body.

4. The wiring rack as claimed in claim 1, wherein the fixing groove is a U-shaped groove.

5. The wiring rack as claimed in claim 1, which is slightly wider than the extension portion.

6. The wiring rack as claimed in claim 1, wherein the extension portion, the wiring rack, and the signal lines on the wiring rack are clad with a plastic material to form a cable.

7. The wiring rack as claimed in claim 1, wherein at least a pair of screw holes is arranged in the rectangular main body at positions adjacent the fixing groove, the wiring rack further comprising:
a cover, provided with a fixing post at positions corresponding to the screw holes of the rectangular main body, and the fixing post being slightly shorter than the screw hole in diameter.
